(19) United States
(12) Patent Application Publication
(10) Pub. No.: US 2011/0016710 A1
(43) Pub. Date: Jan. 27, 2011

(54) ELECTRODE ARRAY ASSEMBLY

(76) Inventors: Fysh Dadd, New South Wales (AU); Claudiu Treaba, Centennial, CO (US)

Correspondence Address: JOHN S. PRATT, ESQ. (Cochlear);KILPATRICK STOCKTON LLP, 1100 PEACHTREE STREET, SUITE 2800, ATLANTA, GA, 30309, US

(21) Appl. No.: 12/810,017

(22) PCT Filed: Dec. 22, 2008
(86) PCT No.: PCT/AU2008/001893

§ 371 Date: Sep. 20, 2010

(30) Foreign Application Priority Data
Dec. 21, 2007 (AU) 2007906988

(51) Int. Cl. H01R 43/16

(52) U.S. Cl. 29/874

(57) ABSTRACT

Disclosed are methods of forming various sub-assemblies of an electrode lead for a medical implant. The method comprises forming a permanent bridge between two or more electrode contacts to provide stability to the sub-assembly to facilitate further processing steps to form the electrode lead. Various sub-assemblies are also disclosed for use in forming the electrode lead.

### CROSS-REFERENCE TO RELATED APPLICATIONS

The present application is a National Stage Application of International Application No. PCT/AU2008/001893, filed on Dec. 22, 2008, entitled “Electrode Array Assembly,” which claims priority from Australian Patent Application No. 2007906988, filed on Dec. 21, 2007, entitled “Electrode Array Assembly,” which is hereby incorporated by reference.

### BACKGROUND

1. Field of the Invention

The present invention relates generally to electrode array assemblies for use in medical implants, and more particularly, to a bridge system used to form an electrode array.

2. Related Art

A variety of medical implants apply electrical energy to the tissue of a patient (also referred to herein as a recipient) to stimulate that tissue. Examples of such implants include, by way of example only and not by way of limitation, pace makers, auditory brain stem implants (ABI), devices using Functional Electrical Stimulation (FES) techniques, Spinal Cord Stimulators (SCS) and cochlear implants (CI).

A cochlear implant allows for electrical stimulating signals to be applied directly to the auditory nerve of a patient, causing the brain to perceive an artificially induced hearing sensation approximating the natural hearing sensation. In some CIs, these stimulating signals are applied by an array of electrodes implanted in the patient's cochlea.

The electrode array of some CIs is in electrical or electromagnetic communication with a stimulator unit which generates the electrical signals that are delivered by the electrode array. The stimulator unit is in electrical or electromagnetic communication with a sound processing unit that in turn is in electrical or electromagnetic communication with a microphone that receives audio signals from the environment and converts those audio signals into electrical or electromagnetic signals. The sound processing unit processes these signals to generate control signals for the stimulator.

The electrode array can be manufactured by placing a plurality (for example 22) of electrode contacts into a welding die, welding a conductive pathway such as a wire to each of the contacts and then removing the resulting weldment from the welding die for further processing. The additional processing of this electrode array sub-assembly, may entail, for example, placing the weldment in a moulding die to form a silicone carrier.

Due to the sometimes fragile nature of the components used in the construction of the electrode array, it is sometimes difficult to perform the removal of the partially assembled electrode array (the weldment) from the welding die without damaging the conductive pathways, electrode contacts, or welded connections. It is also sometimes difficult to avoid disrupting the relative positioning of the electrode contacts while handling the electrode array during further processing steps.

These difficulties may lead to increased complexity in the manufacturing process, an increase in manufacturing costs, and may result in a damaged and reject product, further adding to costs and production delays.

### SUMMARY

According to an aspect of the present invention, there is a method of manufacturing an electrode contact sub-assembly of a medical implant configured to be implanted into a recipient. The method includes placing at least two electrode contacts in a spaced relationship to one another, and connecting at least one permanent bridge to the at least two electrode contacts.

According to a further aspect of the present invention, there is a method of manufacturing an electrode array sub-assembly of a medical implant configured to be implanted into a recipient. The method comprises obtaining an electrode array including at least two electrode contacts with at least one respective conductive pathway extending from each of the at least two electrode contacts. The method further comprises permanently connecting at least one permanent bridge to the at least two electrode contacts.

According to a further aspect of the present invention, there is a method of manufacturing an electrode lead of a medical implant configured to be implanted into a recipient. The method comprises placing an electrode array sub-assembly in a moulding die, the electrode array sub-assembly including at least two electrode contacts each with at least one respective conductive pathway extending from the respective electrode contacts, and at least one permanent bridge connected to the electrode contacts. The method further comprise adding a carrier material to the molding die and allowing the carrier material to cure such that the carrier material attaches to the electrode array sub-assembly including the permanent bridge.

### BRIEF DESCRIPTION OF THE DRAWINGS

The various aspects of the present invention are described in detail with reference to the following drawings in which:

FIG. 1A schematically presents a perspective view of a distal end of an electrode array for use in the various aspects of the present invention;

FIG. 1B schematically presents a perspective view of a distal end of an alternative electrode array for use in the various aspects of the present invention;

FIG. 1C schematically presents a perspective view of a distal end of yet another alternative electrode array for use in the various aspects of the present invention;

FIG. 2 schematically presents a perspective view of a medial section of an electrode array;

FIG. 3 schematically depicts the electrode array of FIG. 2 with the bridge forming an electrode array sub-assembly;

FIG. 4 schematically presents an end view of the sub-assembly of FIG. 3;

FIG. 5 schematically presents a perspective view of an alternative form of bridge;

FIG. 6 schematically presents a perspective view of a further alternative form of bridge;

FIG. 7A schematically presents a perspective view of yet a further alternative form of bridge;

FIG. 7B schematically presents a cross-section along the line A-A of FIG. 7A;

FIG. 8A schematically depicts a partial electrode contact sub-array according to one aspect of the present invention;

FIG. 8B schematically depicts an electrode contact sub-array according to one aspect of the present invention; FIG. 8C schematically depicts the electrode contact sub-array of FIG. 8A with conductive pathways attached;

FIG. 9A depicts a flow chart of the broad steps of one method of forming an electrode contact sub-assembly;

FIG. 9B depicts a flow chart of the steps in a method of forming an electrode array sub-assembly according to an aspect of the present invention;

FIG. 10A depicts a flow chart showing the broad steps of another method of forming an electrode contact sub-assembly;

FIG. 10B is a flowchart of more detailed steps of the method of FIG. 9B;

FIG. 11 is a flow chart of the steps in a method to form an electrode lead according to an aspect of the present invention;

FIG. 12 depicts a flow chart showing the steps of a modified method of forming an electrode lead;

FIG. 13 schematically presents a perspective view of an electrode array in place in a die during the manufacture of an electrode array sub-assembly;

FIG. 14 schematically presents a perspective view of the arrangement of FIG. 13 with a bridge applied;

FIG. 15A schematically presents a cross-section of the electrode array sub-assembly along the line A-A of FIG. 14;

FIG. 15B schematically presents a cross-section of the electrode array sub-assembly along the line B-B of FIG. 14;

FIG. 16 schematically presents the electrode sub-assembly in a curving die to form an electrode lead; FIG. 17A schematically presents an electrode lead formed by the method of FIG. 12;

FIG. 17B schematically presents a cross-section of the electrode lead of FIG. 17A along the line A-A; and

FIG. 18 schematically presents a cochlear implant having a stimulator and electrode lead attached thereto.

### DETAILED DESCRIPTION

Throughout the following description, the term “electrode array” will be understood to mean a collection of two or more electrode contacts and their respective conductive pathways. Throughout the following description, the term “conductive pathway” will be understood to mean any energy-carrying or guiding pathway that will carry or guide energy from one point to another, whether that energy is in the form of electricity, in which case the conductive pathway may be an electrically conductive wire made of any suitable material including platinum or Carbon Nanotubes, or if the energy is in the form of light, the conductive pathway may be for example, an optical fibre or a nanowire.

Throughout the following description, the term “electrode contact” will be understood to mean the element to which energy used to stimulate tissue (“stimulating energy”) is transferred from the conductive pathway, and through which the stimulating energy is applied to the tissue of the implantee. The electrode contact may be in the form of an electrically conductive element, or in other forms, such as by way of example and not by way of limitation, an optical transmitter for applying light or optical energy to the tissue.

Throughout the following description, the term “electrode lead” will be used to mean the electrode array and the carrier material supporting the electrode array. The electrode lead may be connected to the stimulator to transfer stimulating energy to the tissue of the implantee.

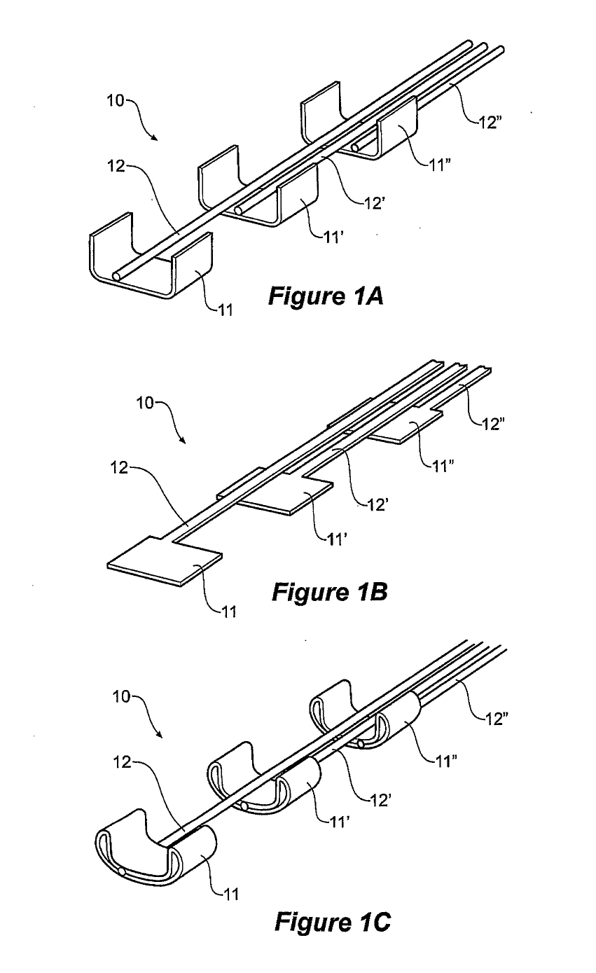

FIGS. 1A, 1B and 1C depict various forms of electrode arrays that may be used with at least some of the various aspects of the present invention. FIG. 1A schematically presents a perspective view of a distal end of an electrode array 10, comprising a plurality of electrode contacts 11, 11′ and 11″ and respective conductive pathways 12, 12′ and 12″. The conductive pathways may be connected to their respective electrode contacts by any suitable means including, by way of example only and not by way of limitation, welding, adhering, crimping or knotting, etc. In an exemplary embodiment, the conductive pathways 12 are provided by conductive wires. In other embodiments, the conductive pathways 12 may be provided by Carbon Nanotubes (CNTs) as described in International Patent Application No. PCT/AU2008/001718. In other embodiments, the conductive pathways may be provided by optical fibers, nanowires or other wave guide to transport optical energy to the electrode contact for optical stimulation of the tissue.

FIG. 1B presents a perspective view of the distal end of an electrode array 10 made, by way of example, from a plurality of electrode contacts 11, 11′ and 11″ with integral respective conductive pathways 12, 12′ and 12″. In one exemplary embodiment, the electrode contact 11 and respective conductive pathway 12 may be formed by stamping from a sheet of suitable material such as platinum, or in another example, a sheet of CNTs.

FIG. 1C depicts a perspective view of another exemplary embodiment of an electrode array 10, with electrode contacts 11, 11′ and 11″ and respective conductive pathways 12, 12′ and 12″ formed in this case by squashing platinum rings to a U-shape to form the electrode contact 11 and trapping the respective conductive pathway 12 therein.

In some embodiments, any other suitable form or arrangement of electrode array may also be used.

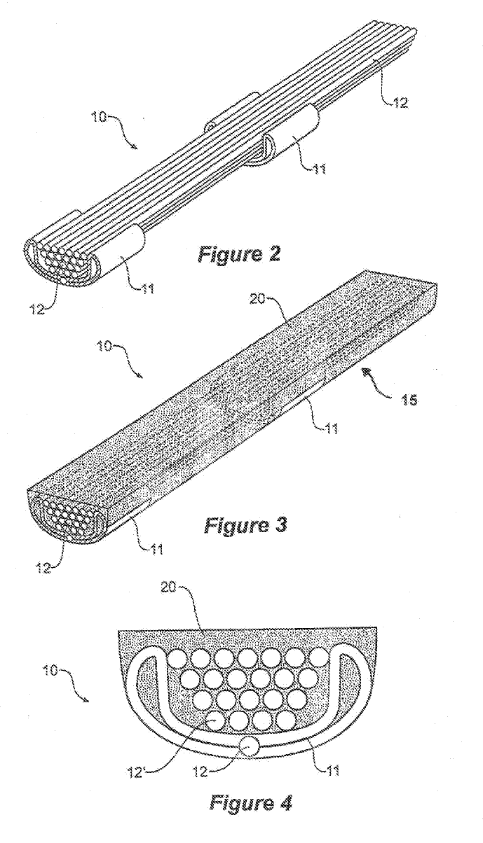

FIG. 2 presents a perspective view of a medial section of an electrode array 10 with electrode contacts 11 and conductive pathways 12 of the form shown in FIG. 1C. As shown in FIG. 2, conductive pathways 12 are laid along the length of the electrode array 10 as defined by the layout of the electrode contacts 11.

In practice, each conductive pathway 12 may be welded or otherwise electrically-connected to a respective electrode contact 11, and run in-line with subsequent electrode contacts 11. The term “in-line,” as used herein means that the contacts are spaced apart in approximate alignment with the longitudinal axis of an electrode lead. In an exemplary embodiment, all of the in-line contacts will have an exposed surface. The contacts may be formed from platinum in some embodiments.

In some embodiments, the resulting assembly may be fragile, and the connections between the conductive pathways 12 and electrode contacts 11, in some instances, may be susceptible to damage during subsequent processing steps. Furthermore, in the resulting electrode assembly, the relative positions of the electrode contacts 11 with respect to each other may be susceptible to disruption.

According to an embodiment of the present invention, a bridge between the electrode contacts may be provided to provide stability between the different elements of the assembly, such as between the contacts 11. According to the present invention, the bridge is a permanent structure, in that the bridge is not removed in a subsequent processing step, and remains a part of the electrode assembly after it is incorporated into an electrode lead configured to be implanted in a human in general, and with respect to cochlear implants, in a human cochlea in particular.

FIG. 3 depicts an electrode array 10 to which at least one permanent bridge as been applied to form the bridge 20, thus forming an electrode array sub-assembly 15 which will be subjected to further processing in subsequent steps. In an exemplary embodiment, the bridge is made of silicone. In an exemplary embodiment, the bridge comprises asilicone adhesive, such as 3-1595 silicone adhesive provided by Dow Corning®, or a High RTV silicone adhesive such as NuSil MED1134 from NuSil Technology LLC. The bridge 20 of the electrode array sub-assembly 15 of FIG. 3 essentially corresponds to a skeleton that supports the electrode array and allows the electrode array to be manipulated in subsequent processing steps with less risk of damage or modification, and the bridge 20 is not removed in later processing steps. That is, the bridge is not a temporary structure that is later removed. Because the bridge is not removed in later processing steps, such potential problems as damaging the electrode array during removal are avoided. Further, the manufacturing process is less complicated, at least in certain respects, if a temporary support structure that needs to be removed is not utilized. For example, the number of manufacturing steps may be reduced without the temporary support structure. The manufacturing time may be reduced without the need to remove a temporary support structure. Further, the use of a temporary structure bonded or otherwise attached to the electrode array may leave behind residue at the attachment areas on the electrode array, which increases the size of the electrode array and may limit design freedom.

Alternative polymers include Liquid Silicone Rubber (LSR), (e.g. from Dow Corning® such as SILASTIC® 7-4860 BIOMEDICAL GRADE LSR or Nusil MED 4860), a Silicone Elastomer (e.g. from Nusil or Dow Corning®); or Parylene C (e.g. from Para Tech Coating, Inc.).

In one embodiment, a combination of the above, and/or other materials, may be used. For example, the bridge 20 may be formed by layered silicone by forming the bridge 20 with a combination of adhesive and LSR, as will be described in more detail later.

FIG. 4 depicts a cross sectional end view of the electrode array sub-assembly of FIG. 3. There can be seen an electrode contact 11 with a respective conductive pathway 12, connected thereto. Also shown in FIG. 4 are other conductive pathways 12′ which are connected to other electrode contacts and which are passing over electrode contact 11. Also visible in FIG. 4 is bridge 20, which in this embodiment, substantially fills the region of the electrode contact 11, covering the conductive pathways which in this case are in the form of platinum wires 12, 12′, although in other embodiments, the bridge 20 does not substantially fill the region of the electrode contacts 11.

In an embodiment utilizing the silicone bridge 20, in subsequent processing steps, additional layers of silicone may be applied to the electrode array sub-assembly. Different silicones have different properties. For example, in one embodiment, the silicone bridge is a silicone adhesive layer securely binding the contacts 11 and optionally, the conductive pathways 12 while having the remaining bulk of the electrode carrier that is used to ultimately form the electrode lead being a liquid silicone rubber (LSR).

In an embodiment of the present invention, there is thus a method of forming an electrode array sub-assembly for use in a medical implant. The method includes obtaining an electrode array comprising at least two electrode contacts with at least one respective conductive pathway, which may be in the form of an electrode array as detailed above, and applying at least one permanent bridge to connect the at least two electrode contacts. The method may further include applying an additional material to the at least two electrode contacts prior to applying the at least one permanent bridge. In an exemplary embodiment, this material may be a silicon adhesive and/or the at least one permanent bridge is made of silicone.

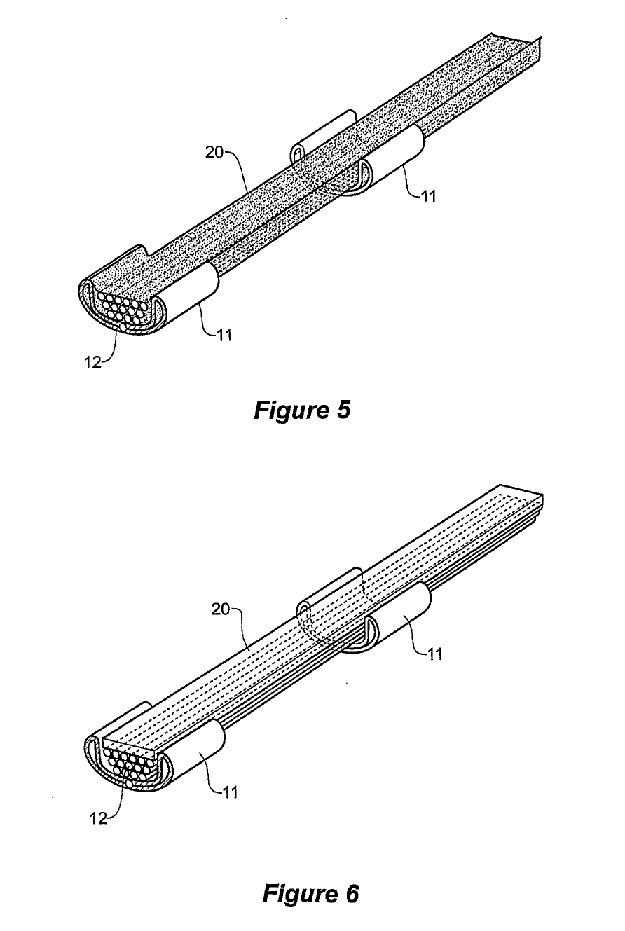

A number of variations may be made to the various aspects of the invention described above. In one exemplary embodiment, instead of injection molding the silicone bridge 20, the bridge 20 could be made by a thin coating/layer. This could be made by, for example, spraying or brushing silicone over the electrode array 10. The silicone may be diluted with N-heptane prior to applying a thin coating layer. An arrangement according to such an embodiment is depicted in FIG. 5, in which the bridge 20 is provided as a thin layer over electrode contacts 11 and conductive pathways 12.

In yet another exemplary embodiment, the bridge 20 could be made from a pre-molded, or otherwise separately-molded, silicone bridge made in a separate step and then attached (e.g. glued with silicone) to the electrode array 10. This attached separately molded silicone bridge would be permanently bonded to the electrode array and thus would become an integral part of the electrode lead that is ultimately implanted in a patient. Such an arrangement is depicted by way of example in FIG. 6, where the bridge 20 is provided by a thin strip of pre-made bridge and then applied over the electrode contacts 11 and wires 12. The bridge 20 may be applied to the electrode contacts only, the conductive pathways only, or to both electrode contact and conductive pathways, or to any other components that will permit the bridge to be utilized to practice embodiments of the present invention. In one embodiment, the bridge is made from LSR, and the LSR bridge is applied or otherwise connected to the electrode contacts only, using silicone adhesive.

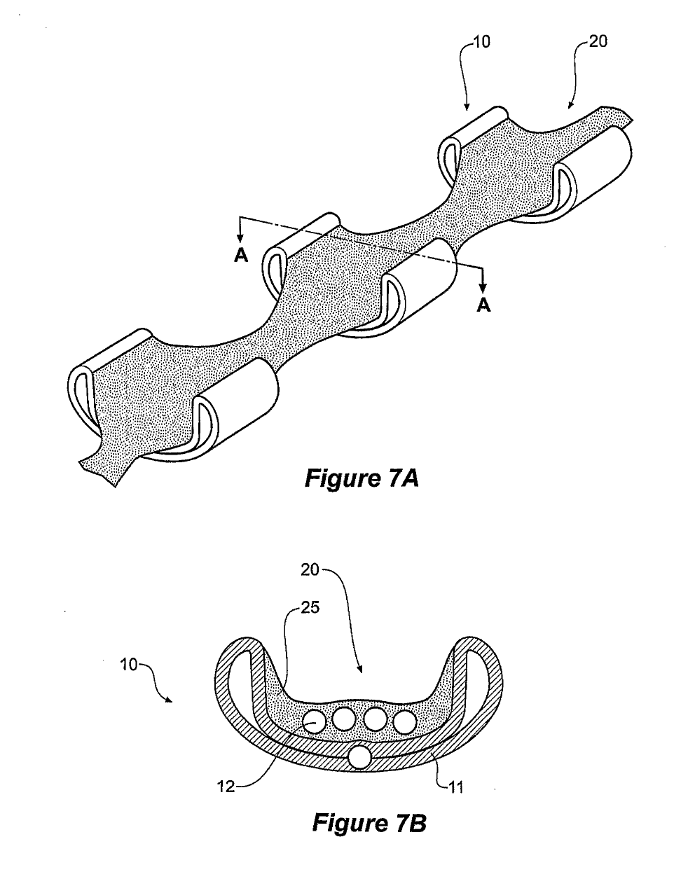

In yet a further exemplary embodiment, “sparing” use of material utilized to form the bridge may be made, as depicted by way of example in FIG. 7A. According to such an embodiment, the bridge 20 is made by applying a relatively thin coating of bridging material (e.g., silicone) along the length of the electrode array 10 before it is removed from the welding die (not shown). Thus, the amount of bridge material in the resulting electrode array sub-assembly is relatively limited as compared to at least some of the other exemplary embodiments.

FIG. 7B depicts a cross sectional view along line A-A of the bridge 20 of FIG. 7A. In an exemplary embodiment, the bridge may be formed by applying a relatively thin coating 25 of bridging material (which may be applied, for example, by spraying, brushing or drizzling silicone over the electrode array 10 while it is located in the welding die (not shown)). The bridging material may be silicone, and may be diluted with N-heptane prior to its application to reduce the silicone's viscosity. Reducing the viscosity of the silicone allows it to be more evenly distributed over the electrode contacts 11 and conductive pathways 12 of the electrode array 10. According to an exemplary embodiment utilizing reduced viscosity silicon, it may be possible to reduce the viscosity of the silicone such that it can flow over the contacts 11 and conductive pathways 12 to form a homogenous mass, while remaining sufficiently viscous to cling to the surface of the electrode array 10. In another exemplary embodiment, the thin coating 25 may be applied by spraying or brushing Parylene over the electrode array 10.

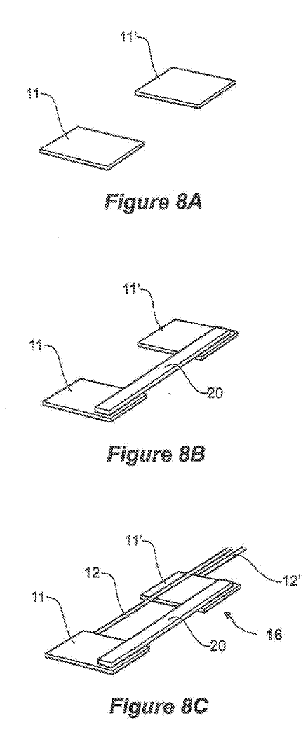

FIGS. 8A to 8C depict an exemplary embodiment entailing the construction of an electrode contact sub-array 16. In this exemplary embodiment, the electrode contacts 11, 11′, etc., may be connected by a bridge without some or all of the conductive pathways being present at the time of bridge connection, to form an electrode contact sub-array 16. FIG. 8A presents two electrode contacts 11 and 11′ that are not mechanically connected to one another by any conductive pathway. These electrode contacts may be of any form, such as, by way of example, the contacts depicted in FIGS. 1A to 1C and variations thereof FIG. 8B depicts the two electrode contacts 11 and 11′ connected by bridge 20 to form the electrode contact sub-array 16. In this embodiment, the bridge 20 conforms to the bridge that is depicted and described by way of example with respect to FIG. 6. Other embodiments may utilize, respectively, any other form of bridge as previously described or as may be extrapolated from the teachings therein, or any other form of bridge that will permit embodiments of the present invention to be practiced. In some embodiments, the bridge 20 may cover all or most or at least some of the electrode contacts 11 and 11′ and holes may be formed in the bridge 20 to accommodate conductive pathways that may be added at a later processing stage. In some embodiments, the conductive pathways may be connected from underneath or on the edges of the electrode contact(s). FIG. 8C depicts the electrode contact sub-array with electrode contacts 11 and 11′ with respective conductive pathways 12, 12′, thus forming an electrode array sub-assembly.

Accordingly, in some embodiments, the bridge may be applied to electrode contacts alone, prior to the attachment of conductive pathways, to provide the relative support and stability for further processing steps, including the addition of conductive pathways.

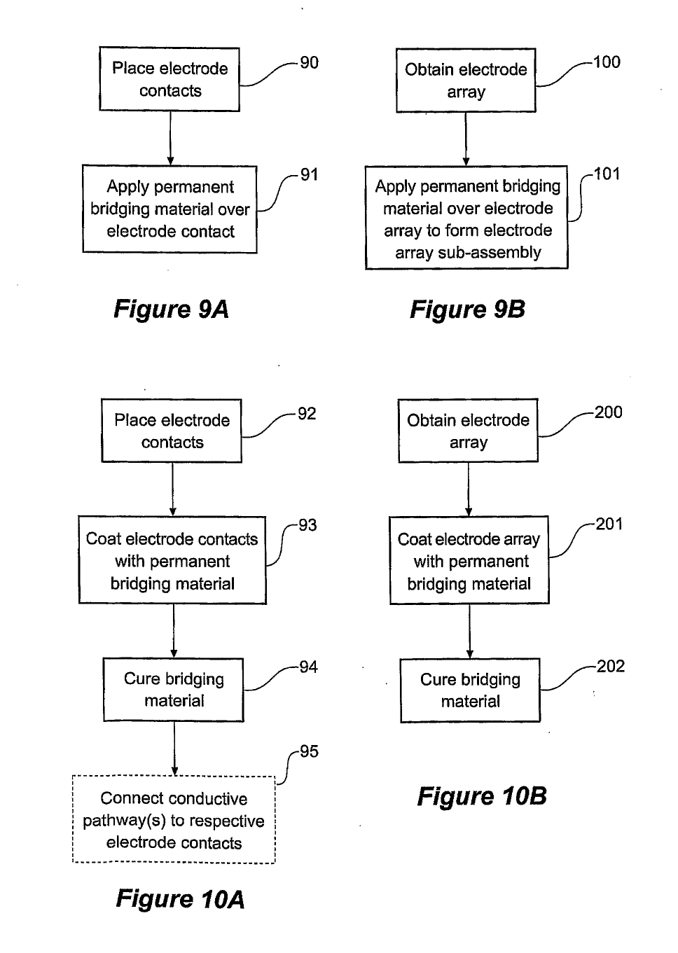

FIG. 9A presents a flow chart of steps involved in constructing an electrode contact sub-array according to an embodiment of the present invention. In step 90, the electrode contacts are placed in a spaced relationship as shown in FIG. 8A. In step 91, the permanent bridge is applied over the electrode contacts to form the electrode contact sub-array, so that it may be further processed.

FIG. 9B presents a flow chart detailing steps of a method of forming an electrode array sub-assembly (which includes the conductive pathways) according to an exemplary embodiment of the present invention. In step 100, an electrode array including contacts with respective conductive pathways such as by way of example, wires, is obtained. In step 102, a permanent bridge such as silicone is applied to the electrode array to support and retain the electrode contacts and respective conductive pathways in relative position to each other. As will be described in more detail later, this electrode array sub-assembly may then be subjected to additional processing, such as inducing a curve onto the sub-assembly or other assembly into which the sub-assembly is applied, or subjected to additional moulding, etc.

FIG. 10A presents a flow chart of exemplary steps of forming an electrode contact sub-assembly according to an exemplary embodiment. In step 92, the electrode contacts are placed in a spaced relationship with respect to each other. In step 93, the electrode contacts are coated with a permanent bridging material. In step 94, the bridging material is cured or otherwise allowed to cure. In an exemplary embodiment, the result of these steps is to form an electrode contact sub-assembly, which may be subjected to additional processing. One exemplary embodiment of further processing is the processing of step 95, which includes connecting one or more respective conductive pathways to the electrode contacts, thus forming an electrode array sub-assembly.

In an exemplary embodiment, a method of forming an electrode contact sub-assembly for ultimate use in a medical implant may include placing at least two electrode contacts in a spaced relationship and connecting the contacts using at least one permanent bridge. The method may further include applying an additional material to the at least two electrode contacts prior to applying the at least one permanent bridge. In an exemplary embodiment, this additional material may be an adhesive. In another embodiment, the method may further include connecting at least one conductive pathway to each of the at least two electrode contacts. The electrode contact sub-assembly for use in a medical implant resulting from one or more of the methods disclosed herein may comprise at least two electrode contacts and at least one permanent bridge connecting the at least two electrode contacts. The electrode contact sub-assembly may further comprise an additional material such as a silicon adhesive disposed between the at least two electrode contacts and the at least one permanent bridge, which may be silicon.

FIG. 10B presents a flowchart of exemplary steps that may be used in a method of manufacturing an electrode array sub-assembly (which includes the electrode pathways) according to an exemplary embodiment of the present invention. In the method according to the flowchart of FIG. 10B, an electrode array including a plurality of electrode contacts with respective conductive pathways, such as by way of example, wires, connected thereto is obtained at step 200. This electrode array is subsequently coated with a bridge, which may comprise silicone, in step 201, and in step 202, the bridging material is cured, or allowed to cure, in accordance with the specifications of the manufacturer of the material.

In an exemplary embodiment, if a layered bridge is used, each layer or a limited number of layers may be cured (or partially cured) prior to the subsequent addition of another layer and/or a limited number of layers, as will be described in more detail further below. In some embodiments, depending upon the choice of silicones used, some may be cured together and some may be cured separately.

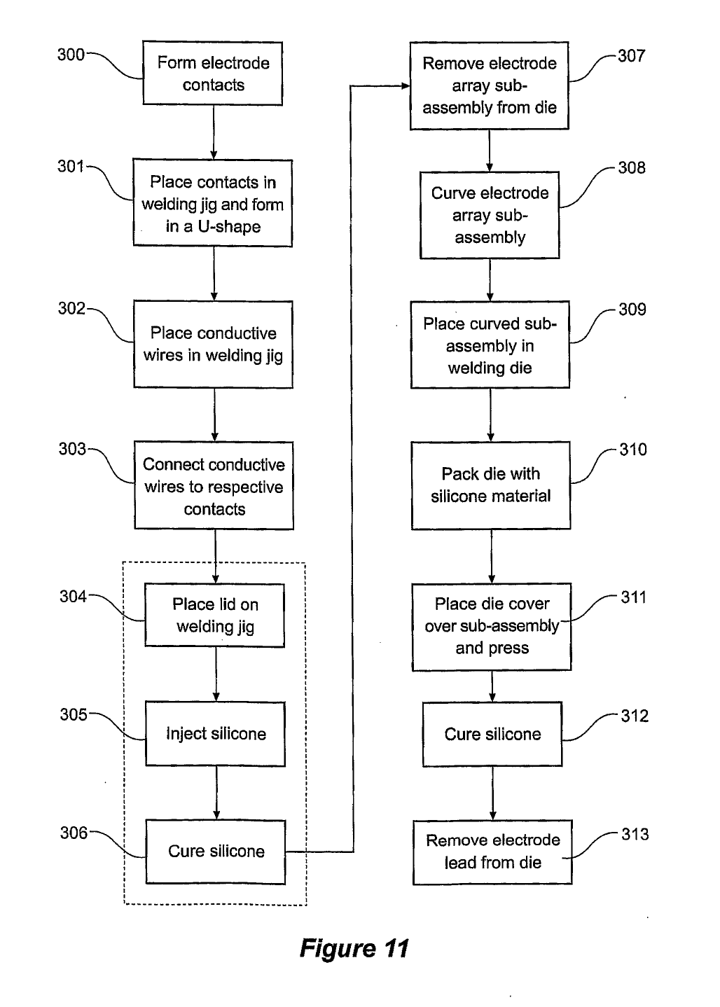

FIG. 11 presents a flowchart detailing exemplary steps involved in a method of forming an electrode lead. The method of FIG. 11 includes the method as described in relation to FIGS. 8 and 9. This method is presented by way of example only for forming an exemplary electrode lead. It is noted that in other embodiments, various variations may be made in relation to one or more of the steps described herein. In the method of FIG. 11, initial steps may include the connection of the conductive pathways or wires 12 to respective electrode contacts 11, for example, by welding. Such a process may correspond to one or more of the processes described by way of example only in U.S. Pat. No. 6,421,569. In step 300, the electrode contacts are formed by slicing 0.3 mm wide sections of platinum tube. In step 301, the formed contacts resulting from step 300 or resulting from a subsequent step are placed in a welding jig and squashed to a U shape. In step 302, a bundle of 22 conductive wires is placed in the welding jig and in step 303, each wire is connected to a respective contact (e.g. by welding). The wire travels from the contact proximally in the bottom of all the proximal U-shaped contacts. In an exemplary embodiment, the conductive pathways will already be connected to their respective electrode contacts such as in the arrangement depicted in FIG. 1B.

The method as previously described with reference to FIG. 9B may be used to continue the process according to the exemplary method of FIG. 11. In step 304, a welding jig lid is placed on the welding jig. In an exemplary embodiment, the welding jig in combination with the welding jig lid forms a die (referred to herein as a welding die). In step 305, bridging material such as silicone is injected into the welding die. In step 306, the die is placed in an oven to cure the silicone, or otherwise allowed to cure on its own and/or with the assistance of a curing agent. The curing may be performed in accordance with the manufacturer's specifications. In an exemplary embodiment, the curing step, in combination with at least some of the other steps, results in an electrode array sub-assembly.

In an exemplary embodiment, subsequent steps involve using the formed electrode array sub-assembly to manufacture an electrode lead. Still referring to FIG. 11, in step 307, the sub-assembly is removed from the welding die. In step 308, the sub-assembly is carefully curved to at least substantially match the shape of a moulding die.

Still referring to FIG. 11, step 309, the sub-assembly is then placed in the moulding die (which is curved) with the electrode contacts being located closer to the medial side (inside of the curve). In an exemplary embodiment, this step is performed to form a carrier about the electrode array sub-assembly.

In step 310, the remaining space in the welding die is then packed with a carrier material such as silicone material. In step 311, a matching die cover is placed over the moulding die and downward pressure is applied to the cover. The moulding die is then placed in an oven to cure the silicone in step 312 (or otherwise allowed to cure on its own and/or with the assistance of a curing agent, and/or in accordance with the manufacturer's specifications) and then in step 313, the die is opened to allow the resulting electrode lead to be removed from the die.

The curved moulding die results in a curved electrode lead. It is noted that in some embodiments, the moulding die is not curved.

In an exemplary embodiment, some or all of the steps involved in moulding of the electrode lead may correspond to those detailed in U.S. Pat. No. 6,421,569.

In an exemplary embodiment, there is a method of forming an electrode lead for a medical implant, comprising placing an electrode array sub-assembly comprising at least two electrode contacts with at least one respective conductive pathway, and at least one permanent bridge connecting the at least two electrode contacts in a die, adding a carrier material to the die, and allowing the carrier material to cure. In an exemplary embodiment, the method further comprises curving the electrode array sub-assembly prior to placing the electrode array sub-assembly in the die, where the die may be a curved die. The method may further comprise placing a production stylet in the die prior to adding the carrier material to form a lumen. An electrode lead for a medical implant resulting from one or more of the methods according to the present invention may include an electrode array sub-assembly comprising at least two electrode contacts with at least one respective conductive pathway and at least one permanent bridge connecting the at least two electrode contacts, and a carrier material supporting the electrode array sub-assembly. In some embodiments, the electrode lead may be curved, and the electrode lead may comprise a lumen.

Various embodiments respectively utilize various configurations and types of moulding dies may be utilized, including straight and partially curved moulding dies.

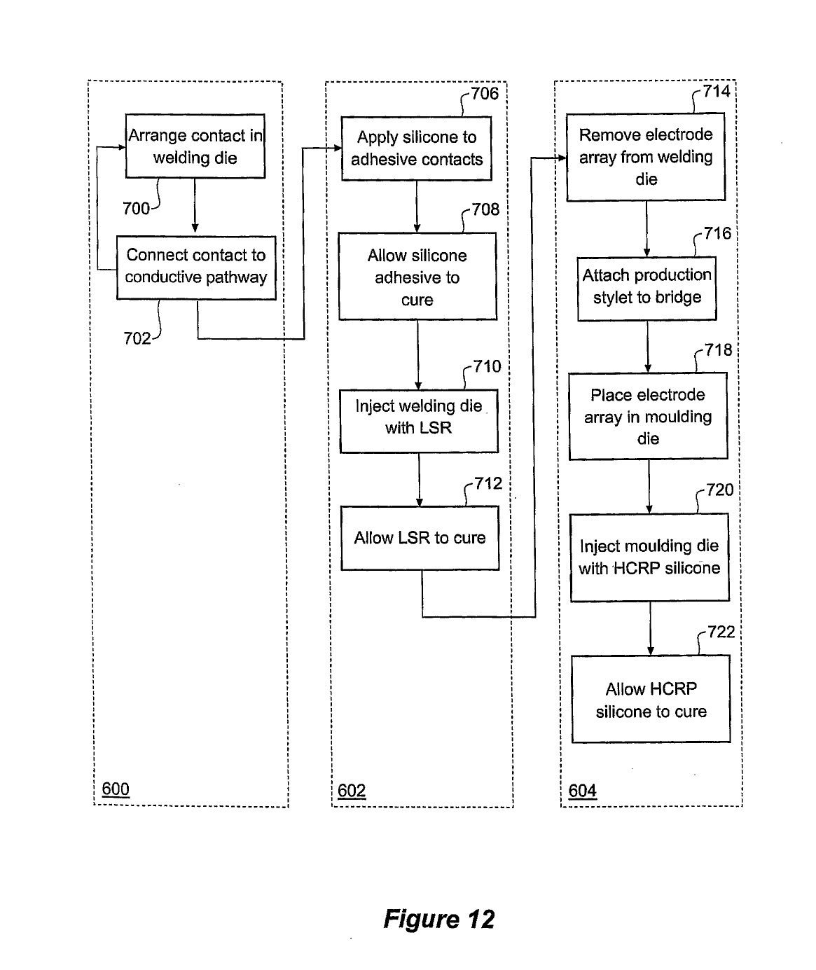

FIG. 12 depicts the steps of an exemplary method of forming an electrode lead according to an embodiment of the present invention. The various steps of this exemplary method are described and further illustrated with respect to FIGS. 12 to 16B.

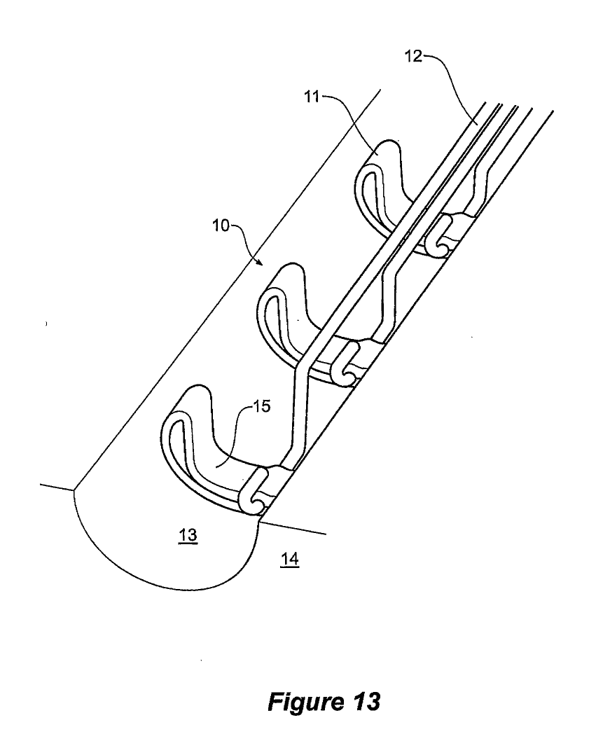

Referring to FIG. 12, the exemplary manufacturing process begins with the initial stage 600 of assembling an electrode array. In step 700, an electrode contact 11 is placed in a straight welding die 14 (see FIG. 13) such that it is located at a proximal end of the U-shaped channel 13. The next step 702 involves connecting each electrode contact 11 to its respective conductive pathway 12. In the embodiment depicted in FIG. 13, each electrode contact 11 is connected to a respective conductive pathway (in this example, an electrically conductive wire) 12 by threading an end of the wire through a ring before squashing the ring downward into the channel 13 of the welding die 14 to form the U-shaped trough 15 of the contact 11. The end of the wire is then folded over and welded to the bottom of the U-shaped trough 15 before placing subsequent rings along the channel 13 of the welding die 14 and drawing their respective wires over and through the trough 15 of each contact 11 previously formed. This process is repeated until all of the contacts 11 have been connected to their respective conductive pathways 12.

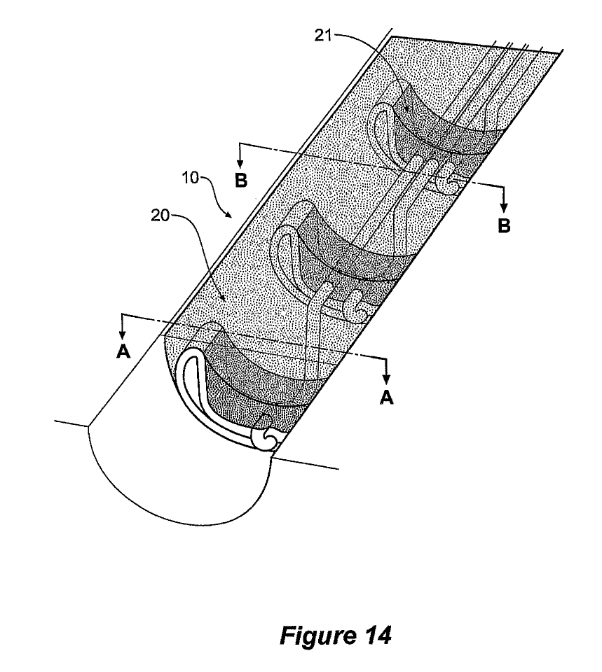

The next stage 602 of the manufacturing process involves forming a bridge 20 over the electrode array 10. As shown in FIG. 14, this involves the step 706 of spraying or otherwise applying a first material 21, such as silicone adhesive, to the surface of each electrode contact. In step 708, the first material 21 is cured by placing the welding die 14 into a heated oven over a period of time, or allowing the silicone to cure on or with the assistance of a curing agent, and/or in accordance with the manufacturer's specifications. After curing the silicone adhesive, a lid (not shown) is placed over the welding die 14 to cover the U-shaped channel 13 before a second material 22, such as liquid silicone rubber (LSR), is injected into the welding die 14 at step 710. In step 712, the welding die 14 is again placed in an oven to allow the second material 22 to cure (or otherwise allowed to cure on its own or with the assistance of a curing reagent and/or in accordance with the manufacturer's specifications) in order to form the bridge 20. This forms the electrode array sub-assembly.

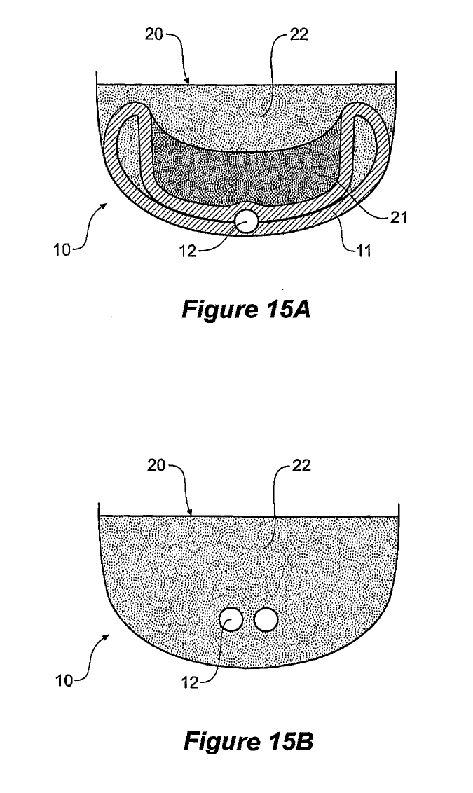

As indicated by step 714, the electrode array sub-assembly may now be removed from the welding die 14. FIGS. 15A and 15B depicts cross-sections of the electrode array sub-assembly taken along the lines A-A and B-B respectively. In FIG. 15A, it can be seen that the bridge 20 comprises a first material 21 and a second material 22, wherein the first material 21 is formed from silicone adhesive applied within the U-shaped trough 15 of each contact 11 as described above by way of example with respect to step 706. Forming the first material 21 from silicone adhesive may, in some embodiments, result in the creation of a relatively stronger bond between the contact 11 and the bridge 20, which may prevent the contact from detaching from the electrode array during explanation of the electrode array. The silicone adhesive may also result in the conductive pathways 12 remaining remain better seated in the U-shaped trough 15 of each contact 11 during further processing. In an exemplary embodiment, the second material 22 is formed from LSR with a Shore hardness ranging between 10 to 80 Durometers.

It is noted that while the schematic in FIG. 15A depicts some of the bridge filling the eyelets as a result of the squashing of the electrode ring, in other embodiments, this may not occur. In some embodiments, there will be no material in the eyelets, while in other embodiments, the eyelets may have a combination of materials therein, depending upon the characteristics of the materials used and the processing methods used, etc.

FIG. 15B depicts a cross sectional view taken long line B-B of the bridge 20 of FIG. 14, wherein only the second material 22 is applied between each contact (not shown). Forming the second material 22 from LSR having a Shore hardness ranging between 10 to 80 Durometers provides the bridge 20 with the required hardness and may also provide some protection to the conductive pathways 12 of the electrode array 10 while is being handled during further processing. It is noted that in some embodiments, the bridge 20 is not needed to provide direct protection to the conductive pathways. The presence of the bridge in providing support to and between the electrode contacts and maintaining the relative positioning between the electrode contacts may also provide some incidental protection to the conductive pathways. In some embodiments, the bridge 20 does not contact or cover the conductive pathways at all. The second material formed of LSR also provides the bridge 20 with structural integrity so the electrode array 10 is adequately supported while it is handled during subsequent processing steps. Using LSR with a Shore hardness ranging between 10 to 35 Durometers may allow the bridge 20 to remain sufficiently flexible so as not to significantly impede or “fight against” any curving force provided by any curved moulded silicone that may be later added, as will be described later.

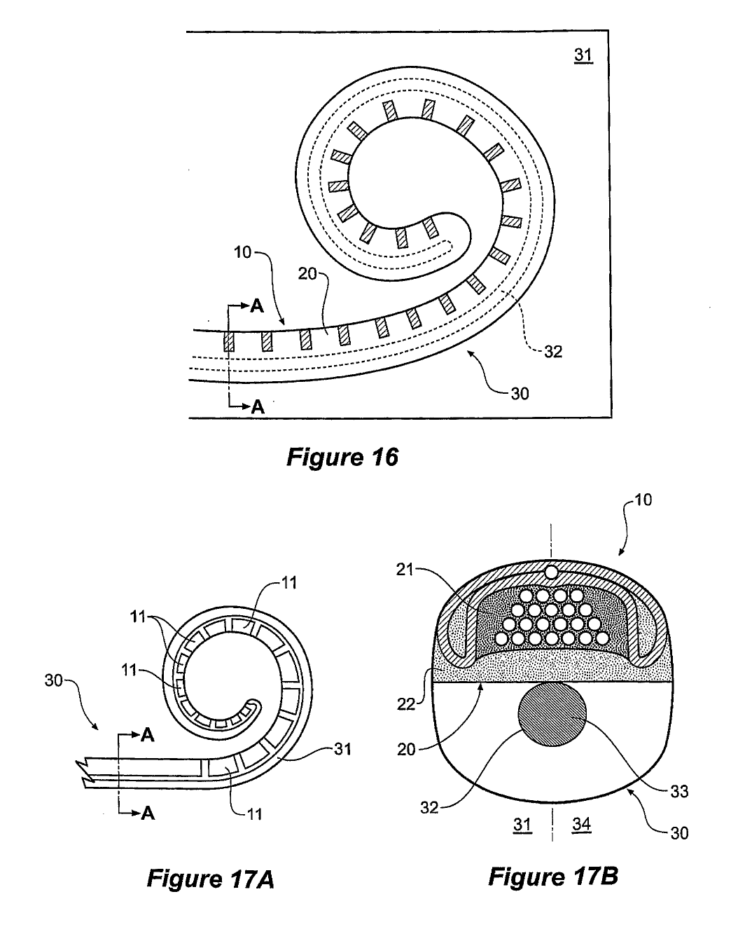

Returning now to the flow chart depicted in FIG. 12. In order to form a lumen 32 in the carrier member 30 as shown in FIG. 16, a production stylet 33 is attached to the bridge 20 in step 716. Various methods of attaching the production stylet 33 may be utilized. In some exemplary embodiments, these methods may correspond to those described in U.S. Pat. No. 6,421,569.

In step 718, the electrode array sub-assembly 10 is placed in the moulding die 31 such that the electrode contacts 11 are located on a medial side (i.e. inside) of the curve. After placement of the electrode array sub-assembly 10 inside the moulding die 31, a matching moulding cover 34 is placed over the moulding die 31 before a High Consistency Peroxide Cure (HCRP) silicone is injected into the moulding die 31 at step 720. In step 722, the moulding die 31 is placed in an oven to allow the HCRP silicone to cure (or otherwise allowed to cure alone or with a curing agent and/or in accordance with the manufacturer's specifications) in order to form the carrier member, resulting in the formation of the fully assembled electrode lead.

The electrode lead according to some embodiments described herein may form the distal end of an electrode lead 30, as is depicted by way of example in FIG. 17A, that is adapted to be connected to an implantable cochlear stimulator (ICS) (not shown). The electrode lead 30 may include the electrode array of electrode contacts 11 and respective conductive pathways 12, the carrier material 31 surrounding the electrode contacts 11 and the bridge located inside.

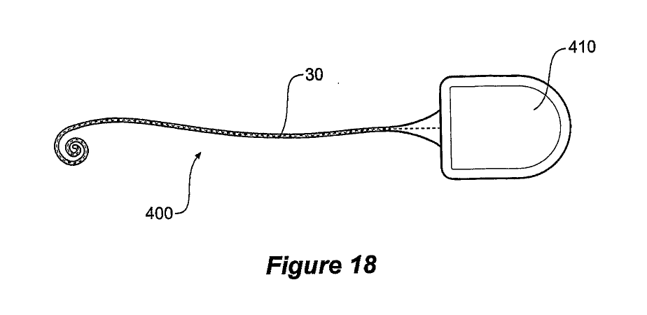

FIG. 17B depicts a cross-section view of the electrode lead of FIG. 17A taken along line A-A. In the embodiment shown, the carrier member 30 is formed from a High Consistency Peroxide Cure (HCRP) silicone with a Shore hardness ranging between about 10 to 80 Durometers. In this instance, it is noted that forming the carrier member 30 from HCRP silicone having a greater Shore hardness than the materials 21, 22 of the bridge 20 allows the carrier member 30 to retain its pre-curved shape. However, it is to be appreciated that any suitable biocompatible material may be used to form the carrier member 30, including LSR and polyurethane rubber, and is not restricted to the specific example given above. As previously described, the formed electrode lead may be attached to a stimulator to form a medical implant, such as a cochlear implant. FIG. 18 shows a cochlear implant 400 having stimulator 410 with electrode lead 30.

In some embodiments, the various teachings disclosed herein, and modifications thereof, may be used in relation to any type of electrode lead, including straight and curved, peri-modiolar electrodes, short/basilar electrodes, as well as electrode arrays with or without lumens or stylets. In some exemplary embodiments, at least some of the various teachings disclosed herein, and modifications thereof, are also combinable with some or all of the features of various electrode arrays described in International Patent Application No. PCT/AU2008/001712 entitled “Lead For A Cochlear Implant”; Australian Provisional Patent Application No. 2007906282 entitled “Electrode Array and Method”; and Australian Provisional Patent Application No. 2007906688 entitled “Stylet For a Medical Implant”.

In some embodiments, at least some of the various teachings disclosed herein, and modifications thereof, are combinable with some or all of the features of other implantable electrode arrays, including auditory brain stem implant (ABI) electrode arrays, Functional Electrical Stimulation (FES) electrode arrays, and Spinal Cord Stimulator (SCS) electrode arrays.

In some embodiments, some or all of the teachings disclosed herein, and modifications thereof, facilitates the holding of the electrode contacts relatively more securely during assembly. In an exemplary embodiment, some or all of the teachings disclosed herein, and modifications thereof, permit more than the typical number of contacts to be used in an electrode array and/or an electrode lead. The number of electrode contacts may vary between 2 contacts and 256 contacts, or even more. Typically, the number of contacts would be 22 as described above. In an exemplary embodiment, more than one conductive pathway or wire 12 may be connected to a single electrode contact 11. Multiple wires may provide redundancy in the eventuality that one of the wires breaks or otherwise fails. In some embodiments, relatively greater mechanical flexibility for a given electrical resistance is provided.

At least some of the teachings disclosed herein have been described in relation to specific embodiments, but various modifications and variations may be readily applied to these teachings. For example, while a bridge comprising two different materials has been described with regard to some embodiments, in other embodiments, a number of materials may be used to construct the bridge. It is also envisaged that the ridge may be comprised of different materials blended together to form an admixture. Alternatively, each material may be applied along the length of the electrode array to form a distinct layer, or to only particular sections of the electrode array, as described in the above embodiment. Furthermore, in some embodiments, different materials may be applied along the length of the electrode array, which may vary the physical properties along the length of the bridge. For example, the bridge may be made relatively softer and more flexible along a distal portion of the electrode array than at a proximal portion of the electrode array to minimize the risk of insertion trauma and resulting damage to residual hearing. As will be understood, in an embodiment of the present invention, there is provided a medical implant comprising a stimulator for generating stimulation signals for stimulating tissue of an implantee, and an electrode lead connected to the stimulator for applying the stimulation signals to the tissue, wherein the electrode lead comprises an electrode array sub-assembly comprising at least two electrode contacts with at least one respective conductive pathway and at least one permanent bridge connecting the at least two electrode contacts. The medical implant further comprises a carrier material supporting the electrode array sub-assembly. In an embodiment, the medical implant is a cochlear implant.

In some embodiments, the use of the bridge according to some embodiments of the present invention permit the costs of manufacturing to be lowered as compared to manufacturing processes using a temporary support structure. In some embodiments, a higher production rate may be achieved as compared to manufacturing processes using a temporary support structure. Also, in some embodiments, the accuracy and/or the precision of the placement of the contacts is increased as compared to manufacturing processes using a temporary support structure.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1.-20. (canceled)

21. A method of manufacturing an electrode contact sub-assembly of a medical implant configured to be implanted into a recipient, the method comprising:
placing at least two electrode contacts in a spaced relationship to one another; and
connecting at least one permanent bridge to the at least two electrode contacts.

22. The method as claimed in claim 21, further comprising applying an adhesive material to the at least two electrode contacts and/or to the permanent bridge prior to connecting the at least one permanent bridge to the at least two electrode contacts.

23. The method of manufacturing an electrode array sub-assembly, comprising:
manufacturing an electrode contact sub-assembly according to claim 21; and
manufacturing an electrode array sub-assembly including the manufactured electrode contact sub-assembly by at least connecting respective conductive pathways to each of the electrode contacts of the at least two electrode contacts.

24. The method of claim 23, wherein the permanent bridge is applied prior to connecting the at least one conductive path to each of the at least two electrode contacts.

25. The method of claim 21, wherein at the time that the at least one permanent bridge is connected to the at least two electrode contacts, the at least two electrode contacts rest in a die or jig, the method further comprising:
removing the at least two electrode contacts from the die or jig while substantially maintaining the spaced relationship between the at least two electrode contacts only as a result of the permanent bridge.

26. The method of claim 23, wherein at the time that the at least one permanent bridge is connected to the at least two electrode contacts, the at least two electrode contacts rest in a die or jig, the method further comprising:
removing the at least two electrode contacts from the die or jig while substantially maintaining the spaced relationship between the at least two electrode contacts only as a result of the permanent bridge and respective conductive pathways extending from respective electrode contacts of the at least two electrode contacts.

27. A method of manufacturing an electrode lead of a medical implant configured to be implanted into a recipient, the method comprising:
manufacturing an electrode contact sub-assembly according to claim 25; and
manufacturing an electrode lead including the manufactured electrode contact sub-assembly by at least attaching a carrier to the electrode contact sub-assembly after the electrode contact sub-assembly is manufactured;
wherein the at least one permanent bridge is included in the manufactured electrode lead.

28. A method of manufacturing an electrode lead of a medical implant configured to be implanted into a recipient, the method comprising:
manufacturing an electrode contact sub-assembly according to claim 26; and
manufacturing an electrode lead including the manufactured electrode contact sub-assembly by at least attaching a carrier to the electrode contact sub-assembly after the electrode contact sub-assembly is manufactured;,
wherein the at least one permanent bridge is included in the manufactured electrode lead.

29. A method of manufacturing an electrode lead according to claim 27, wherein the at least one permanent bridge is made of a non-electrical-conductive material.

30. A method of manufacturing an electrode array sub-assembly of a medical implant configured to be implanted into a recipient, the method comprising:
obtaining an electrode array including:
at least two electrode contacts with at least one respective conductive pathway extending from each of the electrode contacts; and
permanently connecting at least one permanent bridge to the at least two electrode contacts.

31. The method as claimed in claim 30, further comprising:
applying an adhesive material to the at least two electrode contacts prior to connecting the at least one permanent bridge to the at least two electrode contacts.

32. The method as claimed in claim 30, wherein the at least one permanent bridge is made of silicone.

33. The method of claim 30, wherein at the time that the at least one permanent bridge is connected to the at least two electrode contacts, the at least two electrode contacts rest in a die or jig, the method further comprising:
removing the at least two electrode contacts from the die or jig while substantially maintaining a spaced relationship between the at least two electrode contacts only as a result of at least one of:
the permanent bridge; or
the permanent bridge and the respective conductive pathways extending from respective electrode contacts of the at least two electrode contacts.

34. A method of manufacturing an electrode lead of a medical implant configured to be implanted into a recipient, the method comprising:
manufacturing an electrode array sub-assembly according to claim 30; and
manufacturing an electrode lead including the manufactured electrode contact sub-assembly by at least attaching a carrier to the electrode array sub-assembly after the electrode array sub-assembly is manufactured,
wherein the at least one permanent bridge is included in the manufactured electrode lead.

35. A method of manufacturing an electrode lead of a medical implant configured to be implanted into a recipient, the method comprising:
placing an electrode array sub-assembly in a moulding die, the electrode array sub-assembly including at least two electrode contacts each with at least one respective conductive pathway extending from the respective electrode contacts, and at least one permanent bridge connected to the electrode contacts;
adding a carrier material to the moulding die; and
allowing the carrier material to cure such that the carrier material attaches to the electrode array sub-assembly including the permanent bridge.

36. The method as claimed in claim 35, further comprising:
curving the electrode array sub-assembly prior to placing the electrode array sub-assembly in the moudling die.

37. The method as claimed in claim 36, wherein the die is a curved die.

38. The method as claimed in claim 35, further comprising:
placing a production stylet in the die prior to adding the carrier material to form a lumen, wherein the production stylet is attached to the electrode array sub-assembly as a result of the curing of the carrier material.

39. The method of claim 35, wherein the at least one permanent bridge is made of a non-electrical-conductive material.

40. A method of manufacturing a cochlear implant, comprising:
manufacturing an electrode lead according to claim 35; and
placing the manufactured electrode lead into electrical communication with a stimulator of a cochlear implant.
